(19) United States
(12) Patent Application Publication
(10) Pub. No.: US 2013/0328505 A1
(43) Pub. Date: Dec. 12, 2013

(54) Dimmer for Dimmable Drivers

(71) Applicants: Laurence P. Sadwick, Salt Lake City, UT (US); William B. Sackett, Salt Lake City, UT (US)

(72) Inventors: Laurence P. Sadwick, Salt Lake City, UT (US); William B. Sackett, Salt Lake City, UT (US)

(21) Appl. No.: 13/914,142

(22) Filed: Jun. 10, 2013

Related U.S. Application Data
(60) Provisional application No. 61/657,110, filed on Jun. 8, 2012.

(51) Int. Cl. H05B 37/02

(52) U.S. Cl. CPC H05B 37/02
USPC 315/307

(57) ABSTRACT

A dimmer for dimmable drivers.

### CROSS REFERENCE TO RELATED APPLICATIONS

The present application claims priority to (is a non-provisional of) U.S. Pat. App. No. 61/657,110, entitled “Dimmer for Dimmable Drivers”, and filed Jun. 8, 2012 by Sadwick et al, the entirety of which is incorporated herein by reference for all purposes.

### BACKGROUND

Many dimmers currently available cause and produce flicker, flashing and other undesirable effects when used with, for example, LED lighting and LED lighting drivers. In addition, it is often difficult to dim to very low levels (i.e., deep dimming) with Triac dimmers. In certain cases there is not symmetry in the turn on and turn off characteristics. The behavior of many dimmers, including Triac dimmers, is also often influenced by the impedance of the AC lines and due to, for example, other electrical devices and apparatus on the AC lines.

### SUMMARY

A dimmer for dimmable drivers is disclosed herein that can be used to provide power for lights such as LEDs of any type, including organic LEDs (OLEDs), as well as other loads, including but not limited to, fluorescent lamps (FLs) including, and also not limited to, compact fluorescent lamps (CFLs), energy efficient FLs, cold cathode FLs (CCFLs), etc. The dimmer for dimmable drivers may also be used for other dimmable loads such as, but not limited to, fans, motors, heaters, etc. The embodiments disclosed herein are intended to be examples of the present invention and in no way or form should these examples be viewed as being limiting of and for the present invention.

This summary provides only a general outline of some particular embodiments. Many other objects, features, advantages and other embodiments will become more fully apparent from the following detailed description.

### BRIEF DESCRIPTION OF THE DRAWINGS

A further understanding of the various embodiments may be realized by reference to the figures which are described in remaining portions of the specification. In the figures, like reference numerals may be used throughout several drawings to refer to similar components.

FIG. 1 depicts a schematic of a forward dimmer for dimmable drivers in accordance with some embodiments of the invention;

FIG. 2 depicts a schematic of a reverse dimmer for dimmable drivers in accordance with some embodiments of the invention;

FIG. 3 depicts a block diagram of a dimmer for dimmable drivers in accordance with some embodiments of the invention;

FIG. 4 depicts an output voltage waveform for the example embodiment forward dimmer circuit of FIG. 1 at a first dimming level in accordance with some embodiments of the invention;

FIG. 5 depicts an output voltage waveform for the example embodiment reverse dimmer circuit of FIG. 2 at a first dimming level in accordance with some embodiments of the invention;

FIG. 6 depicts an output voltage waveform for the example embodiment forward dimmer circuit of FIG. 1 at a second dimming level in accordance with some embodiments of the invention;

FIG. 7 depicts an output voltage waveform for the example embodiment reverse dimmer circuit of FIG. 2 at a second dimming level in accordance with some embodiments of the invention;

FIG. 8 depicts an output voltage waveform for the example embodiment forward dimmer circuit of FIG. 1 at a third dimming level in accordance with some embodiments of the invention;

FIG. 9 depicts an output voltage waveform for the example embodiment reverse dimmer circuit of FIG. 2 at a third dimming level in accordance with some embodiments of the invention;

FIG. 10 depicts a block diagram of a dimmer for dimmable drivers with a temperature sensor in accordance with some embodiments of the invention;

FIG. 11 depicts a schematic of a ramp signal generator that may be used as a reference source in a dimmer for dimmable drivers in accordance with some embodiments of the invention; and

FIG. 12 is a flow chart of an example operation for dimming in accordance with some embodiments of the invention.

### DESCRIPTION

A dimmer for dimmable drivers is disclosed herein that can be used to provide power for lights such as LEDs of any type, including organic LEDs (OLEDs), as well as other loads, including but not limited to, fluorescent lamps (FLs) including, and also not limited to, compact fluorescent lamps (CFLs), energy efficient FLs, cold cathode FLs (CCFLs), etc. The dimmer for dimmable drivers may also be used for other dimmable loads such as, but not limited to, fans, motors, heaters, etc. The inventions disclosed herein are not limited to the example circuits and applications illustrated, and may be adapted to use with, for example but not limited to, the circuits and applications disclosed in U.S. Patent Application 61/646,289 filed May 12, 2012 for a “Current Limiting LED Driver”, which is incorporated herein by reference for all purposes.

Dimming of lighting is important for numerous reasons and aspects including energy efficiency and meeting the needs of the users under and in various applications. Although there exist numerous dimmers for use with alternating current (AC) sources of power including many based on the use of Triacs to form the active component of the dimmer, dimmers based on Triacs often have negative performance aspects associated the physical principles that underlie, dictate and control the behavior of the Triacs including the need for a minimum trigger current and holding current.

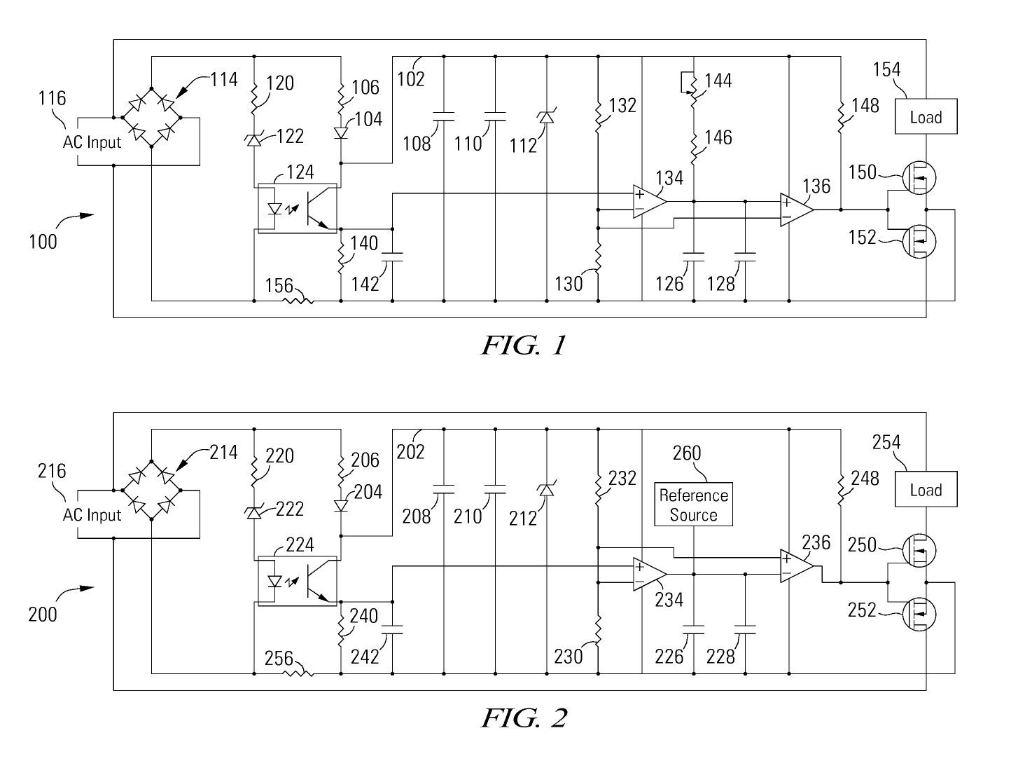

Turning to FIG. 1, an example embodiment of a dimmer 100 for dimmable drivers is disclosed in accordance with some embodiments of the present invention. In some embodiments, a DC power source 102 is generated in dimmer 100 by diode 104, resistor 106, capacitors 108, 110, and Zener diode 112, based on a rectified DC supply provided by diode bridge 114 from AC input 116. The power source for the present invention can be any suitable power source including but not limited to linear regulators and/or switching power supplies and regulators, transformers, including, but not limited to, forward converters, flyback converters, buck-boost, buck, boost, boost-buck, cuk, etc.

In some embodiments, dimmer 100 includes a zero detector circuit comprising resistor 120, Zener diode 122, and opto-coupler 124, which detects zero crossings on both positive and negative pulses at AC input 116, based on the rectified waveform provided by diode bridge 114. Note that, although the example zero detector circuit is shown attached to the DC side of the diode bridge 114, other embodiments of the present invention can use dual/AC opto-couplers/opto-isolators/etc., coils, transformers, windings, current transformers, current sense elements, current sense transformers, etc. The present invention is not limited to the choices discussed above and any suitable circuit, topology, design, implementation, method, approach, etc. may be used to detect zero crossings.

Some embodiments of dimmer 100 include one or more time constants inserted at any suitable location, such as, but not limited to, capacitors 126 and 128 that can be adjusted for, for example, 60 Hz or 50 Hz operation and can be selected by a number of methods including fixed, switch-selectable, automatic, auto-detect, manually set, auto-set, fixed/set for 50 Hz operation, fixed/set for 60 Hz operation, forward/reverse dimming selectable including by any means, examples of which are switches, manual switches, automatic switches and switching, programmable switches, mechanical, electrical, electromechanical, micro-electromechanical systems (MEMS) switches, etc. Although two capacitors 126 and 128 are shown, in general any number of capacitors, N, where N is equal to or greater than 1, can be used for the present invention. In addition, other implementations and embodiments of the present invention can be realized without the direct use of capacitors such as capacitors 126 and 128.

Resistors 130 and 132 form a voltage divider which is used as a reference to comparators 134 and 136. Resistor 140 and capacitor 142 attached to the output of the zero detector opto-coupler 124 allow a momentary negative going pulse to be occur including at the positive input of comparator 134 resulting in the output of comparator 134 resetting in a digital fashion and going to zero volts, after which the output of comparator 134 goes high and charges capacitors 126, 128 according to a time constant dependent, for example, on potentiometer 144, resistor 146, capacitors 126 and 128. In the example embodiment of FIG. 1, comparator 134 is an open collector or open drain comparator, which gains voltage through resistor 146 and potentiometer 144. Comparator 134 may use any design, such as open collector vs internal collector, open drain vs internal drain, etc.

For the forward dimmer, the output of comparator 134 is fed to the positive input of comparator 136. The output of comparator 136 goes and stays high when the voltage at the positive input is higher than the voltage at the negative input, with the voltage at the negative input being set by the voltage divider of resistors 130, 132. The output of comparator 136 is fed to a suitable switch or switching circuit such as, for example, the one consisting of source-to-source common gate connected metal oxide semi-conductor field effect transistors (MOSFETs) 150, 152. Optional pullup resistor 148 may be included to connected between the output of comparator 136 and DC power source 102.

Switching circuit or switches 150, 152 dimmably switch power from the AC input 116 or any other suitable power source to a load 154. Load 154 may be any suitable load, such as a dimmable driver circuits, lamps such as, but not limited to, light emitting diodes (LEDs), organic light emitting diodes (OLEDs), fluorescent, halogen, incandescent and lamps, or other dimmable loads such as, but not limited to, fans and motors.

Resistors 120 and 156 allow the dimmer 100 to float rather than be at a fixed voltage. In other embodiments, the dimmer 100 may be tied to a fixed voltage. In still other embodiments, transformers or other isolation devices may be used. In still other embodiments, capacitors may also be used.

Turning to FIG. 2, another embodiment of a dimmer 200 is disclosed in accordance with some embodiments of the invention. Dimmer 200 operates as a reverse dimmer, with the output of comparator 234 fed to the negative input of comparator 236. The output of comparator 236 goes and stays high when the voltage at the positive input is higher than the voltage at the negative input, with the voltage at the positive input being set by the voltage divider of resistors 230, 232. The output of comparator 236 goes and stays low when the voltage at the negative input of comparator 236 is higher than the voltage of the positive input to comparator 236. The output of comparator 236 is fed to a suitable switch or switching circuit such as the one consisting of source-to-source common gate connected metal oxide semi-conductor field effect transistors (MOSFETs) 250, 252.

In some embodiments, a DC power source 202 is generated in dimmer 200 by diode 204, resistor 206, capacitors 208, 210, and Zener diode 212, based on a rectified DC supply provided by diode bridge 214 from AC input 216. The power source for the present invention can be any suitable power source including but not limited to linear regulators and/or switching power supplies and regulators, transformers, including, but not limited to, forward converters, flyback converters, buck-boost, buck, boost, boost-buck, cuk, etc.

In some embodiments, dimmer 200 includes a zero detector circuit comprising resistor 220, Zener diode 222, and opto-coupler 224. Note that, although the example zero detector circuit is shown attached to the DC side of the diode bridge 214, other embodiments of the present invention can use dual/AC opto-couplers/opto-isolators/etc., coils, transformers, windings, current transformers, etc. The present invention is not limited to the choices discussed above and any suitable circuit, topology, design, implementation, method, approach, etc. may be used to detect zero crossings or to divide positive and negative cycle operation of the dimmer 20.

Some embodiments of dimmer 200 include one or more time constants inserted at any suitable location, such as, but not limited to, capacitors 226 and 228 that can be adjusted for, for example, 60 Hz or 50 Hz operation and can be selected by a number of methods including fixed, switch-selectable, automatic, auto-detect, manually set, auto-set, fixed/set for 50 Hz operation, fixed/set for 60 Hz operation, programmable, auto-learn, auto-determine, etc. Although two capacitors 226 and 228 are shown, in general any number of capacitors, N, where N is equal to or greater than 1, can be used for the present invention. In addition, other implementations and embodiments of the present invention can be realized without the direct use of capacitors such as capacitors 226 and 228.

Resistors 230 and 232 form a voltage divider which is used as a reference to comparators 234 and 236. Resistor 240 and capacitor 242 attached to the output of the zero detector opto-coupler 224 allow a momentary negative going pulse to be occur including at the positive input of comparator 234 resulting in the output of comparator 234 resetting and going to zero volts, after which the output of comparator 234 rises with a time constant dependent, for example, on reference source 260, a voltage or current controlled reference source, which charges capacitors 226 and 228. Reference source 260 may be, for example but not limited to, the potentiometer 144 and/or resistor 146 of FIG. 1, an encoder or decoder permitting digital signals to either or both locally or remotely control the dimming level and state, potentiometer with an analog to digital converter (ADC) or converters (ADCs), a digital to analog converter (DAC), etc.

Optional pullup resistor 248 may be included to connected between the output of comparator 236 and DC power source 202.

Switching circuit or switches 250, 252 dimmably switch power from the AC input 216 or any other suitable power source to a load 254. Load 254 may be any suitable load, such as a dimmable driver circuits, lamps such as, but not limited to, light emitting diodes (LEDs), organic light emitting diodes (OLEDs), fluorescent, halogen, incandescent and lamps, or other dimmable loads such as, but not limited to, fans and motors.

Resistors 220 and 256 allow the dimmer 200 to float rather than be at a fixed voltage. In other embodiments, the dimmer 200 may be tied to a fixed voltage.

Although the example embodiments of dimmers 100 and 200 use MOSFETs, any suitable switch including any suitable transistor including, but not limited to, bipolar junction transistor (BJT), field effect transistor (FET), junction FET (JFET), unijunction FET (UFET), metal emitter semiconductor (MESFET), gallium nitride-based FET (GANFET), silicon carbide (SiC) BJT, SiC FET, diode and/or diodes, combinations of these, etc. can be used.

The switch circuit may contain other elements and components, including, for example, but not limited to, diodes and diode bridges.

Although the example embodiments shown in FIGS. 1 and 2 and discussed above use comparators, the choice of comparators in these example embodiments should not be construed to be limiting in any way or form; other choices including, but not limited to, op amps, difference amplifiers, difference circuits, etc. can be used with and for the present invention. The details of the connections to, for example, comparators versus op amps may change, however the operation is essentially the same.

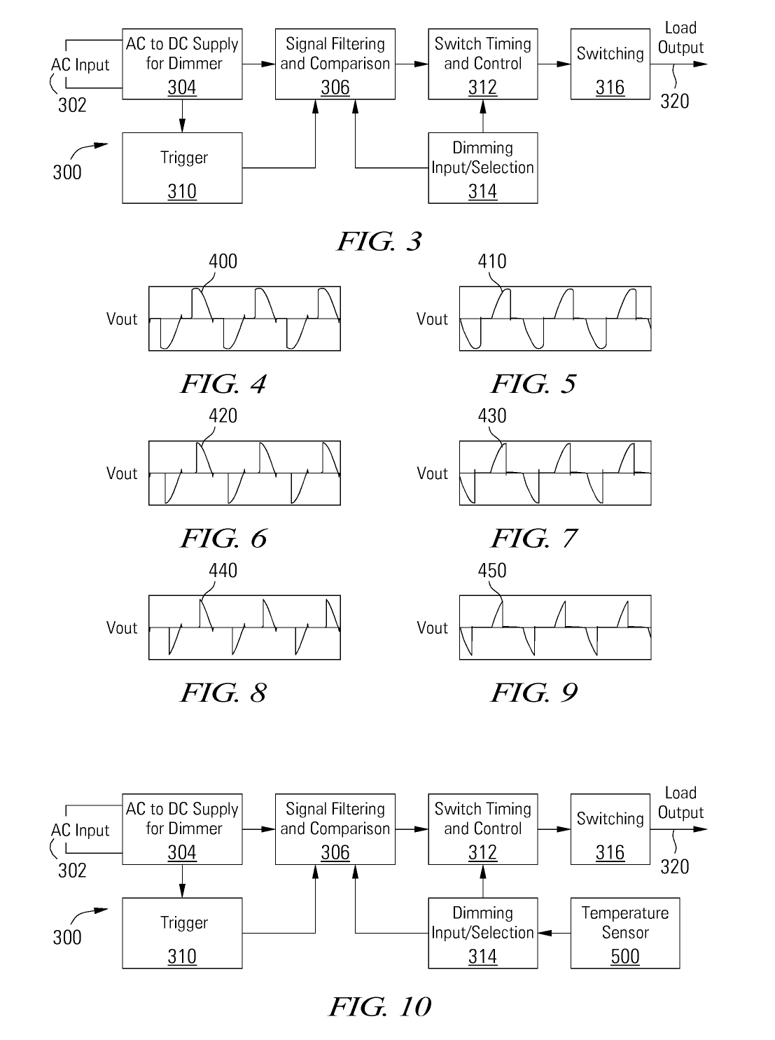

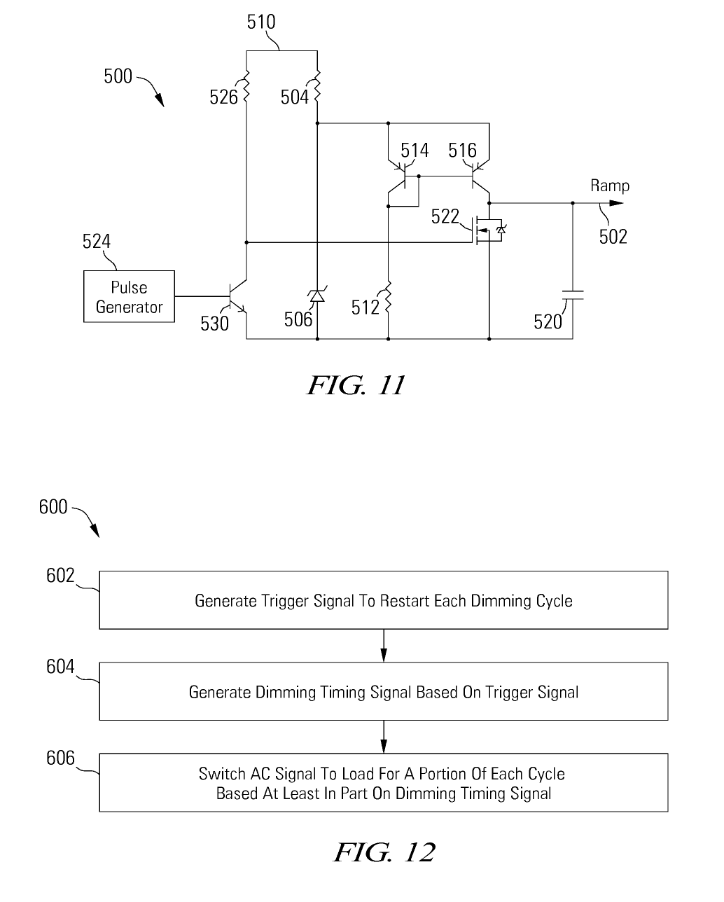

Turning to FIG. 3, a block diagram illustrates a dimmer 300 for dimmable drivers in accordance with some embodiments of the present invention. An AC input 302 is provided to an AC to DC supply 304, which may comprise a diode bridge rectifier and optional signal conditioning components, or any other type of AC to DC supply. Based upon the disclosure provided herein, one of ordinary skill in the art will recognize a variety of circuitry that may be included as part of AC to DC supply 304. In some embodiments as shown in FIG. 1, the AC to DC supply 304 comprises diode bridge 114, diode 104, resistor 106, capacitors 108, 110, and Zener diode 112, based on a rectified DC supply provided by diode bridge 114 from AC input 116.

The AC and/or DC supply is provided to a trigger circuit 310, which is operable to trigger a dimming operation, such as, but not limited to, once per cycle or once per half-cycle of the AC input signal 302. The trigger circuit 310 may comprise, in some embodiments, a zero-crossing detector such as the resistor 120, Zener diode 122, and opto-coupler 124 of FIG. 1, which detects zero crossings on both positive and negative pulses at AC input 116, based on the rectified waveform provided by diode bridge 114. In some embodiments, the trigger circuit 310 may comprise another type of level detector, a timer, a pulse generator, etc. Based upon the disclosure provided herein, one of ordinary skill in the art will recognize a variety of circuitry that may be included as part of trigger circuit 310. For example, timers including monostable, bistable, astable, etc. including timer integrated circuits (ICs) such as the 555 or 566 timer IC or ICs of similar function, operation, etc. may be used in/with the present invention.

A signal filtering and comparison circuit 306 is operable to optionally filter an output of the trigger circuit 310 and to compare the output of the trigger circuit with a reference signal. In some embodiments, as shown in FIG. 1, the signal filtering and comparison circuit 306 comprises a time constant circuit such as resistor 140 and capacitor 142 to filter and/or shape, change, modify, etc. the trigger signal, e.g., the output of opto-coupler 124, and comparator 134 to compare the trigger signal at the output of opto-coupler 124 with the reference signal, version of the DC power source 102, divided by voltage divided resistors 132 and 130. Any other suitable signal filtering and comparison circuit 306 may be used to initiate dimming cycles based upon the output of trigger circuit 310. Based upon the disclosure provided herein, one of ordinary skill in the art will recognize a variety of circuitry that may be included as part of signal filtering and comparison circuit 306.

A switch timing and control circuit 312 is operable to control the timing of a switching circuit 316, based on the output of the signal filtering and comparison circuit 306. In some embodiments, as shown in FIG. 1, the switch timing and control circuit 312 comprises a ramp signal generator such as capacitors 126, 128, resistor 146, and the dimming input potentiometer 144. In some other embodiments, the switch timing and control circuit 312 may comprise other control signal generators such as, but not limited to, the ramp signal generator of FIG. 10. Based upon the disclosure provided herein, one of ordinary skill in the art will recognize a variety of circuitry that may be included as part of switch timing and control circuit 312. The ramp signal may have any waveform with a changing amplitude, such as a rising or falling sawtooth, a triangle waveform, a sinusoidal or partially sinusoidal waveform, a linear or non-linear waveform, etc., which may be used to switch current to a load output or to control the triggering and/or timing of the switching of current to the load output. Various parts of the circuits shown in the figures can be moved around in an interchangeable way to accomplish implementations and operation of the present invention. For example, the location of the ramp, whether towards the front or the back of the circuit, can vary depend on the exact implementation of the present invention; therefore the positions of, for example, the ramp and one or more of the comparator(s) may be different in certain embodiments compared to other embodiments and may appear to have exchanged or interchanged positions/locations in various embodiments of the present inventions while still accomplishing the same overall objective, function and purpose in terms of providing dimming function and dimmer.

A dimming input/selection circuit 314 provides the dimming control of the dimmer 300. The dimming input/selection circuit 314 may comprise any suitable control input, such as the potentiometer 144 of FIG. 1 which adjusts the charging time of capacitors 126, 128, or such as the reference source 260 of FIG. 2 which adjusts the charging time of capacitors 126, 128. In some other embodiments, the dimming input/selection circuit 314 may comprise an encoder or decoder permitting digital signals (including the use of DACs) to either or both locally or remotely control the dimming level and state, potentiometer with an analog to digital converter (ADC) or converters (ADCs), etc., positioned in place of potentiometer 144 or at any other suitable location in the dimmer 300. For example, the dimming input/selection circuit 314 may be used to adjust the voltage to the inverting input of comparator 134 in FIG. 1 by adjusting the resistance of either or both resistors 130, 132. Based upon the disclosure provided herein, one of ordinary skill in the art will recognize a variety of circuitry or inputs that may be used to provide dimming control.

A switching circuit 316 is operable to switch the dimmable output, for example to switch a current from AC input 302 to load output 320. In some embodiments, as in FIG. 1, the switching circuit 316 comprises a comparator 136 which compares the ramp signal with a reference signal from voltage divider resistors 130, 132 to control switches 150, 152. Based upon the disclosure provided herein, one of ordinary skill in the art will recognize a variety of circuitry or inputs that may be included in switching circuit 316.

Turning to FIG. 4, the output voltage waveform 400 is shown for the example embodiment forward dimmer circuit illustrated in FIG. 1. In FIG. 5, the output voltage waveform 410 is shown for the example embodiment reverse dimmer circuit illustrated in FIG. 2. In FIG. 6, the output waveform 420 is shown for the example embodiment forward dimmer circuit illustrated in FIG. 1 under a different setting of the potentiometer 144 (with the potentiometer 144 set such that the dimming circuit example embodiment turns on at around the peak of the AC waveform). In FIG. 7, the output voltage waveform 430 is shown for the example embodiment reverse dimmer circuit illustrated in FIG. 1 under a different setting of the potentiometer 144 (with the potentiometer 144 set such that the dimming circuit example embodiment turns on past the peak of the AC waveform). In FIG. 8, the output waveform 440 is shown for the example embodiment forward dimmer circuit illustrated in FIG. 2 under a different setting of the potentiometer 144 (with the potentiometer 144 set such that the dimming circuit example embodiment turns off around the peak of the AC waveform). In FIG. 9, the output voltage waveform 450 is shown for the example embodiment reverse dimmer circuit illustrated in FIG. 2 under a different setting of the potentiometer 144 (with the potentiometer 144 set such that the dimming circuit example embodiment turns off before the peak of the AC waveform).

In addition to dimming by adjusting, for example, a potentiometer, the present invention can also support all standards, ways, methods, approaches, techniques, etc. for interfacing, interacting with and supporting, for example, 0 to 10 V dimming by, for example, replacing the voltage divider 130, 132 in FIGS. 1 and 2 with a suitable reference voltage that can be remotely set or set via an analog or digital input such as illustrated in patent application 61/652,033 filed on May 25, 2012, for a “Dimmable LED Driver”, which is incorporated herein by reference for all purposes.

The present invention supports all standards and conventions for 0 to 10 V dimming or other dimming techniques. In addition the present invention can support, for example, overcurrent, overvoltage, short circuit, and over-temperature protection.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, digital signal processor(s) (DSPs), complex logic devices, field programmable gate arrays, etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs including, but not limited to, buck, boost-buck, buck-boost, boost, flyback and forward-converters. The present invention itself may also be non-isolated or isolated, for example using a tagalong inductor or transformer winding or other isolating techniques, including, but not limited to, transformers including signal, gate, isolation, etc. transformers, optoisolators, optocouplers, etc.

The present invention may include other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, DSP(s), application specific integrated circuits (ASICs), etc. can also be used either alone or in combinations including analog and digital combinations for the present invention. The present invention can be incorporated into an integrated circuit, be an integrated circuit, etc.

The present invention can also incorporate at an appropriate location or locations one or more thermistors (i.e., either of a negative temperature coefficient [NTC] or a positive temperature coefficient [PTC]) to provide temperature-based load current limiting. As shown in FIG. 10, a temperature sensor 500 may be provided at any suitable location in the dimmer 300. When the temperature rises at the selected monitoring point(s), the phase dimming of the present invention can be designed and implemented to drop, for example, by a factor of, for example, two. The output power, no matter where the circuit was originally in the dimming cycle, will also drop/decrease by a some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, can employ smart and intelligent dimming decisions, artificial intelligence, remote control, remote dimming, etc.

The circuit of FIGS. 1 and 2 may be used in conjunction with dimming to provide thermal control or other types of control to, for example, a dimming LED driver. For example, the circuit of FIGS. 1 and 2 or variations thereof may also be adapted to provide overvoltage or overcurrent protection, short circuit protection for, for example, a dimming LED driver, or to override and cut the phase and power to the dimming LED driver(s) based on any arbitrary external signal(s) and/or stimulus. The present invention can also be used for purposes and applications other than lighting—as an example, electrical heating where a heating element or elements are electrically controlled to, for example, maintain the temperature at a location at a certain value. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless, powerline, etc. and can be implemented in any part of the circuit, including providing for programmable, programming, remote control, monitoring, management, etc. for the present invention. The present invention can be used with a buck, a buck-boost, a boost-buck and/or a boost, flyback, or forward-converter design, topology, implementation, etc.

Turning to FIG. 11, a ramp signal generator circuit 500 is disclosed in accordance with some embodiments of the present invention. The ramp signal generator circuit 500 may be used, for example, to provide a reference signal to a dimmer for dimmable drivers, for example in place of the ramp signal generation that is integrated into the dimmer 100 of FIG. 1 by comparator 134, capacitors 126, 128, resistor 146 and potentiometer 144. In such an embodiment, the ramp signal 502 generated by ramp signal generator circuit 500 may be used at the input to comparator 136 of FIG. 1, to be compared to the reference signal provided by voltage divider resistors 130, 132, with dimming control applied to either or both the ramp signal or the reference signal.

The ramp signal generator circuit 500 generates a voltage reference source with resistor 504 and Zener diode 506, based on a DC rail 510. This voltage reference source is merely for example explanation purposes and should not be viewed as limiting. The voltage reference source is provided to a current source made up of resistor 512 and current mirror 514, 516. The current source at the output of current mirror transistor 516 charges a capacitor 520 to provide the increasing voltage for the ramp signal 502. Switch 522 restarts the ramp signal at each cycle, controlled by a pulse generator 524 through the optional inverting buffer made up of resistor 526 and transistor 530. Timed with each pulse, the switch 522 discharges capacitor 520 to start a new ramp cycle for ramp signal 502. In many embodiments of the present invention the optional inverting buffer is not needed. The pulse generator 524 illustrated in FIG. 11 can be virtually of any type or form including pulse width modulation (PWM), ramp, timer circuits including timers based on the 555 timer, etc. Nothing here should be viewed or construed as limiting in any way or form for the present invention.

The use of a voltage reference in ramp signal generator circuit 500 prevents flickering in a dimmed signal if there are voltage fluctuations at DC rail 510. In some embodiments, Zener diode 506 is replaced with more precise reference voltage devices. The pulse generator 524 is synchronized in some embodiments to an input AC signal, such that the AC signal to a load can be dimmed by turning it off for a portion of each cycle, inexpensively and without flicker.

A dimming voltage signal, VDIM, which represents a voltage from, for example but not limited to, a 0-10 V Dimmer can be used with the present invention; when such a VDIM signal is connected, the output as a function time or phase angle (or phase cut) will correspond to the inputted VDIM.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, DSP(s), complex logic devices, field programmable gate arrays, etc.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc. The present invention can be incorporated or made into an IC, ASIC, incorporated into various other digital and/or analog ICs including, but not limited to, microprocessors, microcontrollers, DSPs, FPGAs, CLDs, op amplifier and/or comparator ICs, etc. or incorporate various digital and/or analog ICs including, but not limited to, microprocessors, microcontrollers, DSPs, FPGAs, CLDs, op amplifier and/or comparator ICs into various implementations of the present invention.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both, heterojunction bipolar transistors (HBTs) of any type, high electron mobility transistors (HEMTs) of any type, unijunction transistors of any type, modulation doped field effect transistors (MODFETs) of any type, etc., again, in general, re-channel or p-channel or both, vacuum tubes including diodes, triodes, tetrodes, pentodes, etc. and any other type of switch, etc.

Turning to FIG. 11, a flow chart 600 depicts a method of dimming in accordance with some embodiments of the invention. Following flow chart 600, a trigger signal is generated to restart each dimming cycle. (Block 602) In some embodiments, the trigger signal provides an indication at each half cycle of an AC input, for example but not limited to, by detecting zero crossings in a rectified AC signal. A dimming timing signal is generated based on the trigger signal. (Block 604) In some embodiments, this is accomplished by comparing the trigger signal with a reference signal, and generating a ramp signal that resets each time the trigger signal crosses the reference signal, and adjusting the slope or another characteristic of the ramp signal based on a dimming input. Current from an AC signal is switched to a load for a portion of each cycle in the AC signal based at least in part on the dimming timing signal. (Block 606)

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. An apparatus for dimming comprising:
a power input;
a load output;
a switching circuit operable to switch a current from the power input to the load output under control of a dimming switching signal; and
a trigger circuit operable to generate a periodic trigger signal;
a comparison circuit operable to compare the periodic trigger signal with a reference signal to generate the dimming switching signal; and
a dimming control input operable to adjust the dimming switching signal.

2. The apparatus of claim 1, wherein the trigger circuit comprises a zero crossing detector.

3. The apparatus of claim 1, wherein the comparison circuit comprises a comparator operable to compare the trigger signal with a reference signal.

4. The apparatus of claim 1, wherein the comparison circuit comprises a ramp signal generator operable generate a ramp signal with a cycle influenced by the trigger signal.

5. The apparatus of claim 4, wherein the ramp signal generator is operable to receive the dimming control input and to generate the ramp signal with a shape determined at least in part by the dimming control input.

6. The apparatus of claim 4, wherein the comparison circuit comprises a comparator operable to compare the ramp signal with a reference signal to yield the dimming switching signal.

7. The apparatus of claim 4, further comprising a reference signal generator operable to generate the reference signal at least in part based on the dimming control input.

8. The apparatus of claim 4, wherein the ramp signal generator comprises a voltage-controlled current source.

9. The apparatus of claim 4, wherein the comparison circuit comprises a comparator operable to compare the trigger signal with a reference signal, and wherein the ramp signal generator comprises at least one capacitor at an output of the comparator and a charge control element controlled by the dimming control input operable to charge the at least one capacitor at a rate determined by the dimming control input when permitted by the comparator.

10. The apparatus of claim 9, wherein the charge control element comprises a potentiometer having an impedance controlled by the dimming control input.

11. The apparatus of claim 1, wherein the dimming control input comprises an element selected from a group consisting of: a potentiometer, an encoder, a decoder, a digital to analog converter, and a 0 to 10 Volt dimming signal.

12. A method of dimming, comprising:
generating a trigger signal to restart each of a stream of dimming cycles;
generating a dimming timing signal based on the trigger signal; and
switching a power source to a load output for a portion of each of a stream of input cycles based at least in part on the dimming timing signal.

13. The method of claim 12, wherein generating a trigger signal comprises activating the trigger signal when a zero crossing is detected in the power source.

14. The method of claim 12, wherein generating the dimming timing signal comprises comparing the trigger signal with a reference signal.

15. The method of claim 14, wherein generating the dimming timing signal further comprises shaping the trigger signal.

16. The method of claim 12, wherein generating the dimming timing signal comprises generating a ramp signal based at least in part on the trigger signal and generating the dimming timing signal based at least in part on the ramp signal.

17. The method of claim 16, wherein the dimming timing signal is generated by comparing the ramp signal with a reference signal.

18. The method of claim 17, wherein the ramp signal is generated based in part on a dimming control input.

19. The method of claim 17, wherein a cycle of the ramp signal is triggered by the trigger signal.

20. The method of claim 12, wherein generating a dimming timing signal and switching the power source based at least in part on the dimming timing signal comprises comparing the trigger signal with a reference voltage, generating a ramp signal with a shape influenced by a dimming control input and restarting the ramp signal based on the comparison of the trigger signal with the reference voltage, and comparing the ramp signal with the reference voltage to control the switching.
